(19) United States
(12) Patent Application Publication
(10) Pub. No.: US 2024/0027279 A1
(43) Pub. Date: Jan. 25, 2024

(54) Systems And Methods For Thermal Monitoring In Integrated Circuits

(71) Applicant: Intel Corporation, Santa Clara, CA (US)

(72) Inventors: Krishnakumar Varadarajan, Bangalore (IN); Aurelien Mozipo, Portland, OR (US); Juan Cevallos Palomeque, Portland, OR (US); Teik Wah Lim, Bayan Lepas (MY); Aanandh Balasubramanian, Bangalore (IN)

(73) Assignee: Intel Corporation, Santa Clara, CA (US)

(21) Appl. No.: 18/476,702

(22) Filed: Sep. 28, 2023

(51) Int. Cl. G01K 1/02; G01K 1/024; G01K 3/08

(52) U.S. Cl. CPC G01K 1/026; G01K 1/024; G01K 3/08; G01K 2217/00; G01K 2213/00

(57) ABSTRACT

A method is provided for thermally monitoring an integrated circuit during operation of the integrated circuit. The method includes receiving a measurement of a temperature in a circuit design for the integrated circuit from a temperature sensor, and determining a hottest temperature in the circuit design based on the measurement of the temperature. A non-transitory computer readable storage medium includes computer readable instructions stored thereon for causing a computing system to receive a measurement of a first temperature in a circuit design for an integrated circuit from a temperature sensor, and determine a second temperature of a cold spot in an active region of the circuit design by adjusting the measurement of the first temperature generated by the temperature sensor by an offset.

### TECHNICAL FIELD

The present disclosure relates to integrated circuits, and more particularly, to systems and methods for thermal monitoring in integrated circuits.

### BACKGROUND ART

In an electronic integrated circuit, the switching frequency of data and/or clock signals in the integrated circuit is related to the temperature of the integrated circuit. Some users of integrated circuits (ICs), such as field programmable gate arrays (FPGAs), have stringent use requirements, including the amount of time the ICs will be in use and the maximum temperatures that the ICs will generate while in use. Manufacturers of ICs often do not know in advance which of their ICs will experience the maximum environmental stresses (e.g., the highest temperatures for the longest periods of time), while being used in specific customer applications.

### BRIEF DESCRIPTION OF DRAWINGS

FIG. 1 is a diagram that illustrates an example of an integrated circuit (IC) die that includes nine temperature sensors.

FIG. 2 is a diagram of a flow chart that illustrates examples of operations that can be performed to generate and update a margin temperature for an integrated circuit (IC) die.

FIG. 3 is a diagram of a flow chart that illustrates examples of operations that can be performed to determine a cold temperature in an integrated circuit (IC) die by correcting a temperature measurement generated by a temperature sensor for an error and for a temperature sensor offset.

FIG. 4 is a diagram of an illustrative example of a configurable integrated circuit (IC) that can include examples disclosed herein.

FIG. 5 is a diagram of a circuit design system that can be used to design integrated circuits in accordance with an embodiment.

FIG. 6 is a diagram of illustrative computer-aided design (CAD) tools that can be used in a circuit design system in accordance with an embodiment.

### DETAILED DESCRIPTION

To ensure that a field programmable gate array (FPGA) is maintained below a specified maximum temperature and to optimize the use of a fan to save power, a customer can control the speed of the fan based on sensor temperature readings from the FPGA. Due to design constraints in many FPGAs, temperature sensors are not placed in the same locations in an FPGA as the hottest spots on the FPGA. Also, the hottest spot in an FPGA can be at different locations for different circuit designs programmed into the FPGA.

Circuit design software tools provide target temperatures for the temperature sensors in an FPGA during pre-design to ensure that the hottest sensor in the FPGA is maintained below limits. However, users often have difficulty identifying the hottest temperature sensor from a list of several temperature sensors (e.g., 30), because the maximum temperature denoted may not attain the highest temperature during operation due to changes in the environmental conditions (e.g., ambient temperature) and design tolerances (e.g., power assumptions). The hottest temperature sensor reported might not represent the hottest point in the circuit design due to varying temperature offsets for different sensors.

An FPGA may have a thermal guard band that accounts for measurement inaccuracies in the temperature readings from temperature sensors in the FPGA. A thermal guard band of 5° C., for example, significantly increases the cooling load of the circuit system and the overall platform power consumption. Because previously there was no way to account for this inaccuracy, the thermal guard band was maintained. Thus, there was no accurate way for customers of FPGAs to control a cooling fan and to maintain the FPGA die temperature without using a large thermal guard band that significantly increases overall cooling power consumption (e.g., by 2 to 8 watts for 1° C. guard band assumption).

FPGA products are designed for flexibility which allows for multiple designs. Every design tends to be unique, and the hot spot location varies between designs. Due to inherent errors in the temperature measurements of temperature sensors in an FPGA, the accuracy of the methodology, and real world variability, it is difficult to meet specifications for all of the temperature sensors in an FPGA simultaneously. Customers do not have visibility into the FPGA floorplan and exact temperature sensor location to identify the best temperature sensor to target for a circuit design for the FPGA. Because the offset between a temperature sensor and the hot spot is different for different temperature sensors, the hottest temperature sensor need not point to the hottest part of the FPGA. Customers have to account for a broad guard band of temperature sensor offset (e.g., at 5° C.), because often no specific information is available or provided regarding the location of the hottest part of the FPGA.

According to some implementations disclosed herein, temperature control in an integrated circuit (IC) die, such as an FPGA, is provided using a margin temperature between the IC die maximum temperature and a hottest location in the IC die. The temperature margin can be used to control a cooling design for the IC die. The calibration error for every temperature sensor in the IC die is calculated as part of the manufacturing process and is stored in the IC die in a secure area or in a remote host. Information on the hottest temperature location in the IC die for any given specific design, along with the positional location of the different temperature sensors are stored in a secure area of the IC die or a host. Using this information, a computer system identifies the most appropriate temperature sensor for a given hot spot, monitors the temperature of that specific temperature sensor, reduces temperature measurement sensor error by correcting for the calibration error, adds the appropriate temperature offset between that temperature sensor and the hottest temperature in the IC die, and provides a corrected temperature as an output.

Using some of the techniques disclosed herein, the thermal guard band for temperature measurement from temperature sensors in an IC die can be reduced significantly (e.g., from 5° C. to 1° C.), which can substantially reduce power consumption of a fan used to cool the IC die. These techniques can also reduce the cost of the IC die. The computer system selects the most appropriate temperature sensor in the IC die, ensuring that the temperature of the IC die hot spot is maintained below required levels. In addition, the techniques disclosed herein can make control of the fan used to cool the IC die easier by providing a user with only one single temperature margin value used for a fan control mechanism.

One or more specific examples are described below. In an effort to provide a concise description of these examples, not all features of an actual implementation are described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

This disclosure discusses circuit systems that can be implemented in integrated circuit devices, including programmable logic devices such as field programmable gate arrays (FPGAs). As discussed herein, circuit systems may use hard logic and soft logic of an FPGA. As used herein, “hard logic” generally refers to circuits in an integrated circuit device (e.g., a programmable logic integrated circuit) that are not programmable by an end user. The circuits in the integrated circuit device that are programmable by the end user are considered “soft logic.”

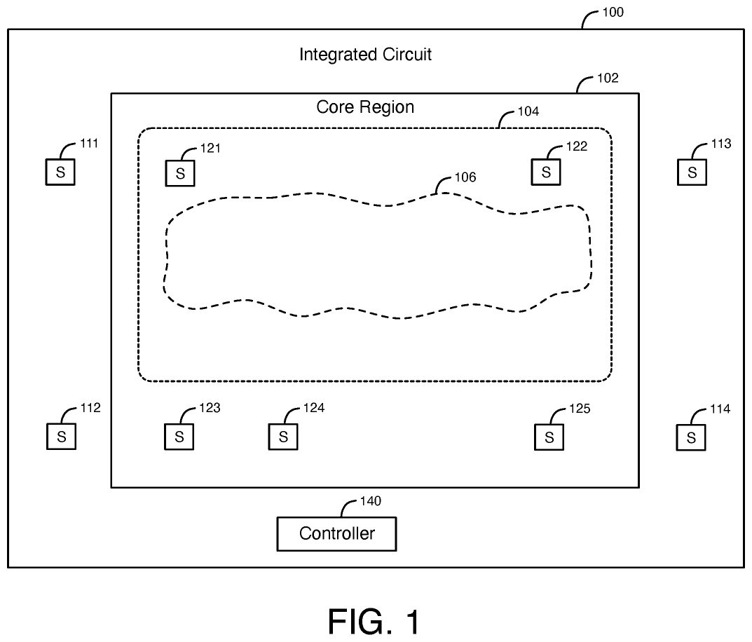

FIG. 1 is a diagram that illustrates an example of an integrated circuit (IC) die 100 that includes nine temperature sensors 111-114 and 121-125 (e.g., diodes) and a controller circuit 140. IC 100 of Figure (FIG. 1 also includes a core region 102 that has an active region 104 and a hot region 106. The core region 102 of IC 100 includes temperature sensors 121-125, and the peripheral region of the IC 100 includes temperature sensors 111-114. Temperature sensors are also referred to herein as temperature monitors. IC 100 can be any type of IC such as a programmable logic IC (such as an FPGA), a microprocessor or central processing unit (CPU) IC, a graphics processing unit (GPU) IC, a memory IC, an application specific IC (ASIC), etc. If IC 100 is a programmable (configurable) logic IC, the core region 102 may include soft logic (programmable logic circuits).

For IC die 100, spatial temporal calibration data is generated at manufacturing that contains the spatial information of the location of each of the different temperature sensors 111-114 and 121-125 and the calibration data for each of the temperature sensors 111-114 and 121-125. During the manufacturing stage of each IC die, such as IC 100, every IC die and every temperature sensor on each IC die is calibrated as part of a standard sorting process. The calibration process can include generating calibration data for each of the temperature sensors in the IC die. The calibration data can include, for example, error information that indicates the error between a temperature measured by each of the temperature sensors 111-114 and 121-125 and the actual temperature of the IC die 100 at the location of the respective temperature sensor. Thus, the error information indicates the temperature error inherent in each temperature sensor in the IC die. In addition, the calibration data of the temperature sensors for each IC die and identifiers for the temperature sensors are stored in a database with the spatial temporal calibration data and/or stored within the IC die (e.g., in fuses).

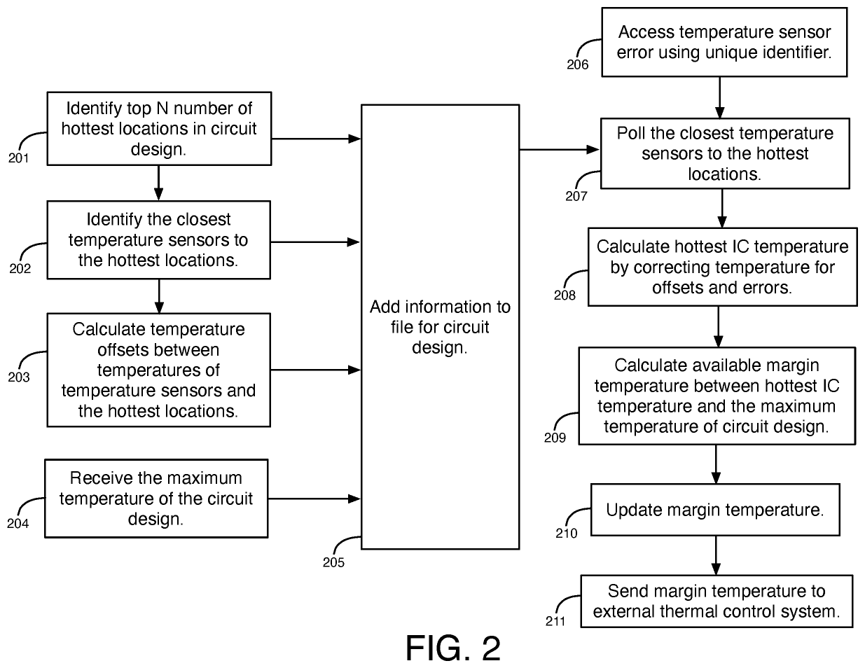

FIG. 2 is a diagram of a flow chart that illustrates examples of operations that can be performed to generate and update a margin temperature for an integrated circuit (IC) die. The margin temperature can be used, for example, to control an external thermal control system for the IC die. The IC die can be any type of IC, such as an FPGA, a microprocessor, a GPU, an ASIC, etc., as discussed above. The operations of FIG. 2 can be performed by one or more software tools running on the IC die (e.g., in controller circuit 140 or a controller circuit in core region 102 in IC 100) and/or on one or more computing systems, such as for example, software run as a remote service on one or more server computers and/or a local software program run on a local computing system. The operations 201-205 of FIG. 2 can, for example, be performed by an electronic design automation (EDA) tool for an IC.

In operation 201, the top N number of hottest locations (i.e., hot spots) in a circuit design for the IC die are identified. As an example, the top N number of hottest locations in the circuit design for the IC die can be identified using a temperature map of the circuit design for the IC die during a design phase of the circuit design. The temperature map can be generated by a computer aided design (CAD) software tool using, for example, information about power consumption and/or timing characteristics of logic circuits in the circuit design for the IC die that affect the temperature of the logic circuits. The temperature map can be generated for a circuit design for the IC die one time during the design phase of the circuit design. Then, adjustments can be made to estimates of the temperatures of hot spots in the circuit design based on recent measurements of temperatures by one or more temperature sensors in the IC die, as disclosed herein in further detail below.

Some implementations are disclosed herein in the context of FPGAs for illustrative purposes. These FPGA implementations are provided as examples and are not intended to be limiting. For example, when an FPGA device is configured, an EDA tool fetches the spatial temporal calibration data discussed above from the database and programs the spatial temporal calibration data to the FPGA device. The EDA tool then analyzes the temporal behavior of the circuit design for the FPGA per the FPGA configuration. The EDA tool calculates and saves the hottest locations in the FPGA in operation 201.

In operation 202, the one or more temperature sensors in the circuit design for the IC die are identified that are closest to the hottest locations identified in operation 201. As an example, the closest temperature sensor(s) to the hottest locations in the circuit design for the IC die can be identified using the temperature map during the design phase of the circuit design. As an example, the temperature sensors 121-122 in FIG. 1 can be identified as the closest temperature sensors in IC 100 to the top N hottest locations in hot region 106.

In operation 203, the temperature offsets (i.e., the temperature differences) between the temperatures measured by the one or more temperature sensors identified as being closest to the hottest locations in operation 202 and the temperatures at the N respective hottest locations identified in operation 201 are calculated. In operation 204, a target maximum temperature T_{MAX} of the circuit design for the IC die is received (or identified). The target maximum temperature of the circuit design can be, for example, a value that is provided by a user of the software tool that creases the circuit design.

The information generated and/or received in operations 201-204 is added to a file for the circuit design for the IC die in operation 205 (e.g., by an EDA tool). The information added to the file includes the N hottest locations in the IC identified in operation 201, the one or more closest temperature sensors to the hottest locations identified in operation 202, the temperature offsets calculated in operation 203, and the maximum temperature of the circuit design received in operation 204. If the IC die is a configurable logic IC, the file is a bitstream configuration file that contains a bitstream to be used to configure the IC die to perform the functions of the circuit design, and the information from operations 201-204 is added to the bitstream configuration file in operation 205. After the file for the circuit design is updated with the information from operations 201-204, the file is provided to a remote device, a telemetry circuit in the IC, a control circuit in the IC (e.g., controller circuit 140 or a secure device manager (SDM)), and/or to another device, circuit, system, and/or software tool. This device, circuit, system, and/or software tool performs operations 207-211 using the updated file. The IC die is configured using the bitstream configuration file updated in operation 205 (i.e., if the IC die is a configurable logic IC), or the IC die is manufactured using the file updated in operation 205 (e.g., if the IC die is an ASIC).

In operation 206, the error information indicating a measurement error for each of the temperature sensors in the IC die is accessed from the calibration data of the temperature sensors stored in the database or in the IC die using the unique identifiers for the temperature sensors and/or for the IC die. In operation 207, the one or more temperature sensors closest to the hottest locations in the IC die that were identified in operation 202 are polled during operation of the IC die after the IC die has been manufactured with or configured according to the circuit design. Measurements of temperatures generated by these temperature sensors are then received by the device, circuit, system, and/or software tool.

In operation 208, the hottest temperature T H in the IC die is calculated by correcting the temperatures received in operation 207 for the temperature offsets calculated in operation 203 and for the errors indicated by the error information received in operation 206 for these respective temperature sensors. In operation 209, the available margin temperature T_{MRN} is calculated between the hottest temperature T H in the IC die calculated in operation 208 and the maximum temperature T_{MAX} of the circuit design received in operation 204 (e.g., T_{MRN}=T_{MAX}−T_{H}). In operation 210, the margin temperature currently associated with the circuit design is updated with the margin temperature calculated in operation 209.

In operation 211, the margin temperature T_{MRN} calculated in operation 209 and updated in operation 210 is sent to an external thermal control system. The external thermal control system can include, as examples, a circuit board fan, a chassis temperature controller, or a building temperature control system. The external thermal control system can be part of, or separate from, the one or more computing systems that perform operations 201-211. The external thermal control system can then make adjustments to the amount of cooling provided to the IC die based on the margin temperature, such as adjusting the speed of a fan used to cool the IC die. The external thermal control system can maintain the temperature of the IC die at an optimal threshold and can aid in substantial energy use reductions. In addition, the margin temperature generated by the process of FIG. 2 can eliminate the need to use a thermal guard band for the IC die.

For example, if the margin temperature T_{MRN} is small, the hottest temperature of the IC die is close to the maximum temperature T_{MAX} of the circuit design. In response to a small margin temperature T_{MRN}, the external thermal control system can set the fan at a high speed to provide more cooling to the IC die. As another example, if the margin temperature T_{MRN} is large, the hottest temperature of the IC is significantly less than the maximum temperature T_{MAX} of the circuit design. In response to a large margin temperature T_{MRN}, the external thermal control system can set the fan at a low speed to provide less cooling to the IC.

The performance of an integrated circuit depends in part on the delays of the circuits within the integrated circuit. Temperature and voltage are among the many factors that affect circuit delays. At low voltages, circuit delays increase with decreasing temperature, which is referred to as the inverse temperature dependence. To account for the inverse temperature dependence and to provide a gradual change in delay to reduce the risk of failure, an integrated circuit can include an inverse temperature dependence (ITD) compensation feature. According to this feature, firmware initially reads a temperature sensor. When this temperature sensor measures a temperature below a predefined temperature (e.g., 85° C.), the firmware adjusts the supply voltage provided to circuits in the integrated circuit using curve based ITD compensation and applies a margin (e.g., 5° C.) to the temperature input to account for the error inherent to the temperature sensor.

However, the ITD compensation feature can contain two separate error sources with data based margins. The error sources are the remote sensor estimation error and the remote temperature measurement accuracy error. Based on these errors, the root means squared (RMS) error range can be, as an example, +/−7° C. Depending on the power profile used, the temperature sensor may read a higher or a lower temperature (e.g., +/−5° C.) than the cool part of the core region used by the circuit design in an IC, such as an FPGA.

According to other implementations disclosed herein, a software tool captures a temperature offset for a circuit design for an IC die, and the temperature offset is passed to a controller circuit as an input value. The temperature offset is used to reduce the remote sensor estimation error to a prediction error (e.g., +/−1° C.). The calibration data for the temperature sensor can be used by firmware in the IC to accurately calculate a cold temperature of an active region of the IC and correspondingly apply a temperature compensation voltage to a supply voltage in the IC. This technique can reduce the remote temperature measurement accuracy error in the temperature sensor measurement substantially (e.g., to +/−0.5° C.).

By splitting the error sources, each error source can be accurately captured and reduced. The estimation error calculation obviates aggressive or conservative error assumptions that can create increased power consumption or cause timing failure. The techniques disclosed herein can prevent having to use the worst case thermal guard band (e.g., +/−7° C.) uniformly across all IC dies. In addition, the firmware can accurately calculate the temperature for each IC die to apply the correct temperature compensation voltage to the supply voltage, which reduces the overall error significantly (e.g., from +/−7° C. to +/−1.5° C.) and reduces power usage.

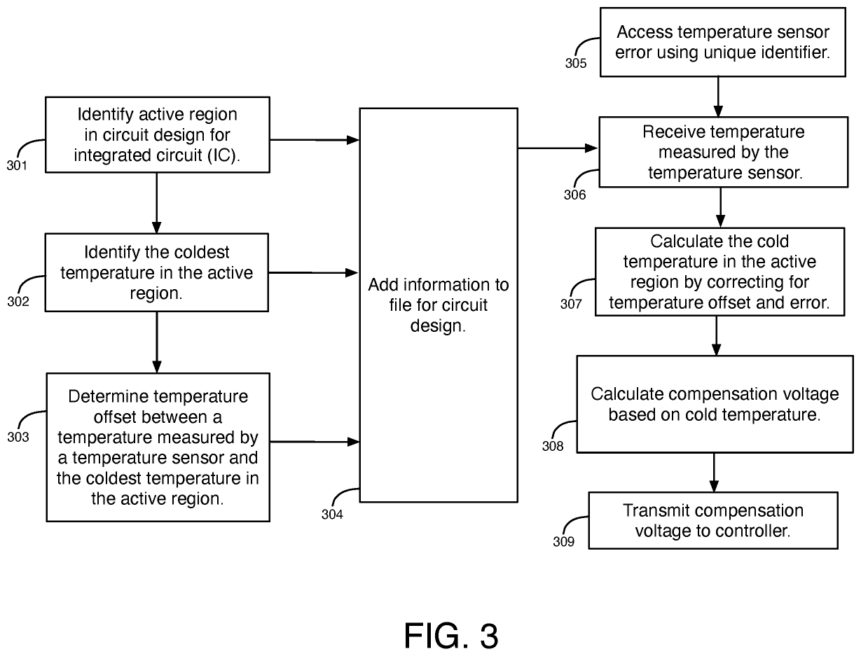

The temperature at a location in an IC die is often inferred from the temperatures measured by sensors located in other parts of the IC die. Using a temperature sensor in a remote location relative to a location of a desired temperature measurement can lead to a temperature estimation error. According to implementations that are disclosed herein with respect to FIG. 3, a computing system can determine a cold temperature in an active region of an integrated circuit (IC) by correcting a temperature measurement generated by a temperature sensor for an error and for a temperature offset.

FIG. 3 is a diagram of a flow chart that illustrates examples of operations that can be performed to determine a cold temperature in an integrated circuit (IC) die by correcting a temperature measurement generated by a temperature sensor for an error and for a temperature sensor offset. The IC die can be any type of IC, such as an FPGA, a microprocessor, a GPU, an ASIC, etc., as discussed above. The operations of FIG. 3 can be performed by one or more software tools running in the IC die (e.g., in controller circuit 140 or a controller circuit in core region 102 in IC 100) and/or on one or more computing systems, such as for example, software run as a remote service on one or more server computers and/or a local software program run on a local computing system. The operations 301-304 can, for example, be performed by an electronic design automation (EDA) tool for an IC.

In operation 301, an active region in a circuit design for an integrated circuit (IC) die is identified. Active regions of a circuit design for an IC die are regions of the circuit design that are generating significantly more heat than other regions of the circuit design as a result of circuit activity in the active regions. FIG. 1 illustrates an example of an active region 104 of IC 100. The active region in the circuit design can be identified, for example, using a temperature map of the circuit design for the IC die during a design phase of the circuit design. The temperature map can be generated by a computer aided design (CAD) software tool using, for example, information about power consumption and/or timing characteristics of logic circuits in the circuit design for the IC die that affect the temperature of the logic circuits. The temperature map can be generated for a circuit design for the IC die one time during the design phase of the circuit design. Then, adjustments can be made to estimates of the temperatures of cold spots in the circuit design based on recent measurements of temperatures by one or more temperature sensors in the IC die, as disclosed herein in further detail below.

In operation 302, the coldest temperature is identified in the same active region of the circuit design that was identified in operation 301. As an example, the coldest temperature in the active region can be identified using a temperature map of the circuit design for the IC die during the design phase of the circuit design. The coldest temperature may be located in a cold spot in the active region.

In operation 303, the temperature offset is determined between a temperature measured by a selected temperature sensor in the IC die and the coldest temperature in the active region that was identified in operation 302. The temperature sensor selected in operation 303 can be any temperature sensor in the IC die. The temperature sensor selected in operation 303 can be, as an example that is not intended to be limiting, in or next to a control circuit in the IC die, such as a SDM or controller circuit 140.

In operation 304, the information identified and determined in operations 301-303 is added to a file for the circuit design for the IC die (e.g., by an EDA tool). The information added to the file in operation 304 can include the active region of the IC identified in operation 301, the coldest temperature in the active region, and the temperature offset determined in operation 303. If the IC die is an FPGA, the file is a bitstream configuration file that contains a bitstream to be used to configure the FPGA to perform the functions of the circuit design, and the information from operations 301-303 is added to the bitstream configuration file in operation 304. After the file for the circuit design is updated with the information from operations 301-303, the file is provided to a remote device, a telemetry circuit in the IC, a control circuit (e.g., an SDM or controller circuit 140) in the IC, or to another device, circuit, or system. This device, circuit, system, and/or software tool operating thereon then performs operations 305-309 using the updated file. The IC die is configured using the bitstream configuration file updated in operation 304 (i.e., if the IC die is a configurable logic IC), or the IC die is manufactured using the file updated in operation 304 (e.g., if the IC die is an ASIC).

In operation 305, the error information indicating the error inherent in the temperature sensor used in operation 303 is accessed from the calibration data using the unique identifier for the temperature sensor. The error information can be, as examples, accessed from a database or stored in memory in the IC die. As a more specific example, the error information can be fused into fuses in the IC die that are not accessible for customer usage. During configuration of an FPGA, a default value in the configuration bitstream is replaced by the respective die calibration fuse value, and firmware uses the calibration fuse value as an offset value for every temperature measurement received from the temperature sensor.

In operation 306, the temperature sensor used in operation 303 is polled during operation of the IC die after the IC die has been manufactured with or configured according to the circuit design. A temperature measured by this temperature sensor is then received by the device, circuit, system, and/or software tool in operation 306. In operation 307, a cold temperature T_{COLD} in the active region is calculated by correcting the temperature received in operation 306 for the temperature offset calculated in operation 303 and for the error indicated by the error information received in operation 305 for the temperature sensor. The cold temperature T_{COLD} in the active region that is calculated in operation 307 can be, as examples, the coldest temperature in the active region or one of the coldest temperatures in the active region. In operation 307, the temperature T_{S} measured by the temperature sensor and received in operation 306, the error T_{E} of the temperature sensor accessed in operation 305, the temperature offset T_{OFF} determined in operation 303, and an overall temperature error T_{OVL} (e.g., 1.5° C.) for the IC die are used to calculate the cold temperature T_{COLD} (i.e., T_{COLD}=T_{S}−T_{E}−T_{OFF}−T_{OVL}).

In operation 308, a compensation voltage is calculated for a supply voltage that is provided to circuits in the IC die based on the cold temperature calculated in operation 307. In operation 309, the compensation voltage is transmitted to a controller. The controller can be controller circuit 140 in IC die 100 or external to the IC die. The controller adjusts the supply voltage in the IC die based on the compensation voltage calculated in operation 308. For example, the controller can increase the supply voltage by the compensation voltage in order to decrease the delays of the circuits in the IC die that receive the supply voltage. The delays of these circuits may increase in response to the cold temperature T_{COLD} in the active region. The supply voltage can be provided only to one region of the IC die or to circuitry in the entire IC die.

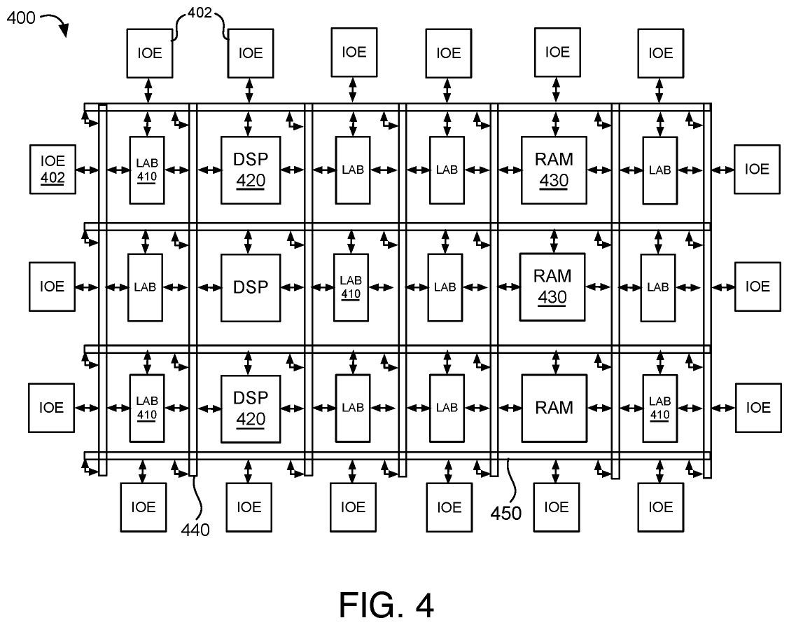

FIG. 4 is a diagram of an illustrative example of a configurable integrated circuit (IC) 400. Configurable IC 400 is an example of an IC die as disclosed herein, such as IC die 100. As shown in FIG. 4, the configurable integrated circuit 400 includes a two-dimensional array of functional blocks, including logic array blocks (LABs) 410 and other functional blocks, such as random access memory (RAM) blocks 430 and digital signal processing (DSP) blocks 420, for example. Functional blocks, such as LABs 410, may include smaller programmable regions (e.g., logic elements, configurable logic blocks, or adaptive logic modules) that receive input signals and perform custom functions on the input signals to produce output signals.

In addition, the configurable integrated circuit 400 may have input/output elements (IOEs) 402 for driving signals off of configurable integrated circuit 400 and for receiving signals from other devices. Input/output elements 402 may include parallel input/output circuitry, serial data transceiver circuitry, differential receiver and transmitter circuitry, or other circuitry used to connect one integrated circuit to another integrated circuit. As shown, input/output elements 402 may be located around the periphery of the IC. If desired, the configurable integrated circuit 400 may have input/output elements 402 arranged in different ways. For example, input/output elements 402 may form one or more columns of input/output elements that may be located anywhere on the configurable integrated circuit 400 (e.g., distributed evenly across the width of the configurable integrated circuit). If desired, input/output elements 402 may form one or more rows of input/output elements (e.g., distributed across the height of the configurable integrated circuit). Alternatively, input/output elements 402 may form islands of input/output elements that may be distributed over the surface of the configurable integrated circuit 400 or clustered in selected areas.

The configurable integrated circuit 400 may also include programmable interconnect circuitry in the form of vertical routing channels 440 (i.e., interconnects formed along a vertical axis of configurable integrated circuit 400) and horizontal routing channels 450 (i.e., interconnects formed along a horizontal axis of configurable integrated circuit 400), each routing channel including at least one track to route at least one wire.

Note that other routing topologies, besides the topology of the interconnect circuitry depicted in FIG. 4, may be used. For example, the routing topology may include wires that travel diagonally or that travel horizontally and vertically along different parts of their extent as well as wires that are perpendicular to the device plane in the case of three dimensional integrated circuits, and the driver of a wire may be located at a different point than one end of a wire. The routing topology may include global wires that span substantially all of configurable integrated circuit 400, fractional global wires such as wires that span part of configurable integrated circuit 400, staggered wires of a particular length, smaller local wires, or any other suitable interconnection resource arrangement.

Furthermore, it should be understood that examples disclosed herein may be implemented in any type of integrated circuit. If desired, the functional blocks of such an integrated circuit may be arranged in more levels or layers in which multiple functional blocks are interconnected to form still larger blocks. Other device arrangements may use functional blocks that are not arranged in rows and columns.

Configurable integrated circuit 400 may contain programmable memory elements. Memory elements may be loaded with configuration data (also called programming data) using input/output elements (IOEs) 402. Once loaded, the memory elements each provide a corresponding static control signal that controls the operation of an associated functional block (e.g., LABs 410, DSP 420, RAM 430, or input/output elements 402).

In a typical scenario, the outputs of the loaded memory elements are applied to the gates of field-effect transistors in a functional block to turn certain transistors on or off and thereby configure the logic in the functional block including the routing paths. Programmable logic circuit elements that may be controlled in this way include parts of multiplexers (e.g., multiplexers used for forming routing paths in interconnect circuits), look-up tables, logic arrays, AND, OR, NAND, and NOR logic gates, pass gates, etc.

The memory elements may use any suitable volatile and/or non-volatile memory structures such as random-access-memory (RAM) cells, fuses, antifuses, programmable read-only-memory memory cells, mask-programmed and laser-programmed structures, combinations of these structures, etc. Because the memory elements are loaded with configuration data during programming, the memory elements are sometimes referred to as configuration memory or programmable memory elements.

The programmable memory elements may be organized in a configuration memory array consisting of rows and columns. A data register that spans across all columns and an address register that spans across all rows may receive configuration data. The configuration data may be shifted onto the data register. When the appropriate address register is asserted, the data register writes the configuration data to the configuration memory elements of the row that was designated by the address register.

Configurable integrated circuit 400 can include configuration memory that is organized in sectors, whereby a sector may include the configuration RAM bits that specify the function and/or interconnections of the subcomponents and wires in or crossing that sector. Each sector may include separate data and address registers.

The configurable IC of FIG. 4 is merely one example of an IC that can be used with embodiments disclosed herein. The embodiments disclosed herein can be used with any suitable electronic integrated circuit or system. For example, the embodiments disclosed herein can be used with numerous types of electronic devices such as processor integrated circuits, central processing units, memory integrated circuits, graphics processing unit integrated circuits, application specific standard products (ASSPs), application specific integrated circuits (ASICs), and configurable logic integrated circuits. Examples of configurable logic integrated circuits include programmable arrays logic (PALs), programmable logic arrays (PLAs), field programmable logic arrays (FPGAs), electrically programmable logic devices (EPLDs), electrically erasable programmable logic devices (EEPLDs), logic cell arrays (LCAs), complex programmable logic devices (CPLDs), and field programmable gate arrays (FPGAs), just to name a few.

The integrated circuits disclosed in one or more embodiments herein can be part of a data processing system that includes one or more of the following components: a processor; memory; input/output circuitry; and peripheral devices. The data processing system can be used in a wide variety of applications, such as computer networking, data networking, instrumentation, video processing, digital signal processing, or any suitable other application. The integrated circuits can be used to perform a variety of different logic functions.

It can be a significant undertaking to design and implement a desired (custom) logic circuit design in a programmable logic integrated circuit (IC). Logic designers therefore generally use logic design systems based on computer-aided-design (CAD) tools to assist them in designing circuits. A logic design system can help a logic designer design and test complex circuits for a system. When a design is complete, the logic design system can be used to generate configuration data for electrically programming the appropriate programmable logic IC.

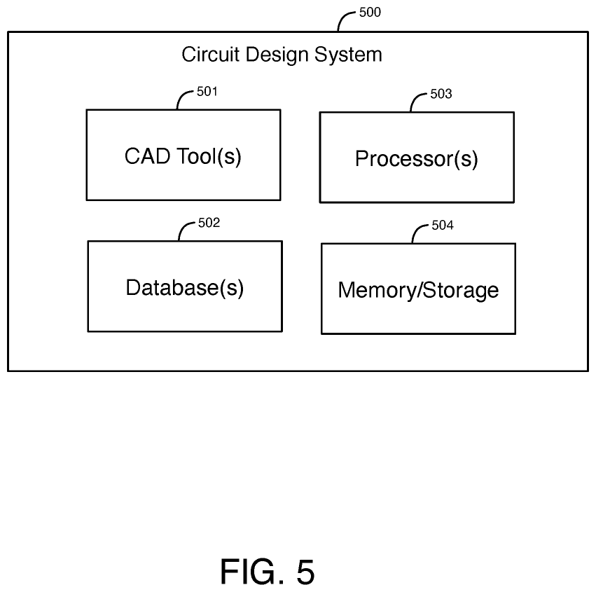

An illustrative circuit design system 500 in accordance with an embodiment is shown in FIG. 5. If desired, the circuit design system of FIG. 5 can be used in a logic design system. Circuit design system 500 can be implemented on integrated circuit design computing equipment. Circuit design system 500 can, for example, include one or more networked computer systems with processors, memory, mass storage, input/output devices, etc. System 500 can, for example, be based on one or more processors 503 such as personal computers, workstations, etc. The processor(s) 503 can be linked using a network (e.g., a local or wide area network). Memory in these computers or external memory and storage devices (collectively shown as memory/storage 504 in FIG. 5) can be used to store instructions and data.

Software-based components such as computer-aided design (CAD) tool(s) 501 and database(s) 502 reside on system 500. During operation, executable software such as the software of computer aided design tool(s) 501 runs on the processor(s) of system 500. CAD tools 501 can include the CAD tool disclosed herein. Database(s) 502 are used to store data for the operation of system 500. In general, software and data may be stored in non-transitory computer readable storage media (e.g., tangible computer readable storage media). The software code may sometimes be referred to as software, data, program instructions, instructions, or code. The non-transitory computer readable storage media may include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

Software stored on the non-transitory computer readable storage media may be executed on system 500. When the software of system 500 is installed, the storage of system 500 has instructions and data that cause the computing equipment in system 500 to execute various methods (processes). When performing these processes, the computing equipment is configured to implement the functions of circuit design system 500.

The computer aided design (CAD) tool(s) 501, some or all of which are sometimes referred to collectively as a CAD tool, a circuit design tool, or an electronic design automation (EDA) tool, may be provided by a single vendor or by multiple vendors. Tool(s) 501 may be provided as one or more suites of tools (e.g., a compiler suite for performing tasks associated with implementing a circuit design in a programmable IC) and/or as one or more separate software components (tools). Database(s) 502 may include one or more databases that are accessed only by a particular tool or tools and may include one or more shared databases. Shared databases may be accessed by multiple tools. For example, a first tool may store data for a second tool in a shared database. The second tool may access the shared database to retrieve the data stored by the first tool. This allows one tool to pass information to another tool. Tools may also pass information between each other without storing information in a shared database if desired.

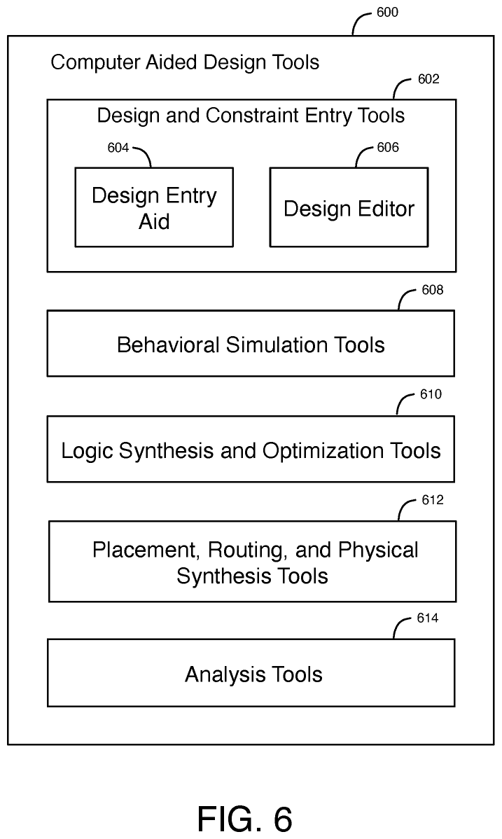

Illustrative computer aided design tools 600 that can be used in a circuit design system such as circuit design system 500 of FIG. 5 are shown in Figure (FIG. 6. The design process can start with the formulation of functional specifications of the integrated circuit design (e.g., a functional or behavioral description of the integrated circuit design). A circuit designer can specify the functional operation of a desired circuit design using design and constraint entry tools 602. Design and constraint entry tools 602 can include tools such as design and constraint entry aid 604 and design editor 606. Design and constraint entry aids such as aid 604 can be used to help a circuit designer locate a desired design from a library of existing circuit designs and can provide computer-aided assistance to the circuit designer for entering (specifying) the desired circuit design. Design and constraint entry tools 602 can allow a circuit designer to enter timing constraints for the desired circuit design through aid 604.

As an example, design and constraint entry aid 604 can be used to present screens of options for a user. The user can click on on-screen options to select whether the circuit being designed should have certain features. Design editor 606 can be used to enter a design (e.g., by entering lines of hardware description language code), can be used to edit a design obtained from a library (e.g., using a design and constraint entry aid), or can assist a user in selecting and editing appropriate prepackaged code/designs.

Design and constraint entry tools 602 can be used to allow a circuit designer to provide a desired circuit design using any suitable format. For example, design and constraint entry tools 602 can include tools that allow the circuit designer to enter a circuit design using truth tables. Truth tables can be specified using text files or timing diagrams and can be imported from a library. Truth table circuit design and constraint entry can be used for a portion of a large circuit or for an entire circuit.

As another example, design and constraint entry tools 602 can include a schematic capture tool. A schematic capture tool can allow the circuit designer to visually construct integrated circuit designs from constituent parts such as logic gates and groups of logic gates. Libraries of preexisting integrated circuit designs can be used to allow a desired portion of a design to be imported with the schematic capture tools.

If desired, design and constraint entry tools 602 can allow the circuit designer to provide a circuit design to the circuit design system 500 using a hardware description language such as Verilog hardware description language (Verilog HDL), Very High Speed Integrated Circuit Hardware Description Language (VHDL), SystemVerilog, or a higher-level circuit description language such as OpenCL or SystemC, just to name a few. The designer of the integrated circuit design can enter the circuit design by writing hardware description language code with editor 606. Blocks of code can be imported from user-maintained or commercial libraries if desired.

After the circuit design has been entered using design and constraint entry tools 602, behavioral simulation tools 608 can be used to simulate the functionality of the circuit design. If the functionality of the design is incomplete or incorrect, the circuit designer can make changes to the circuit design using design and constraint entry tools 602. The functional operation of the new circuit design can be verified using behavioral simulation tools 608 before synthesis operations have been performed using tools 610. Simulation tools such as behavioral simulation tools 608 can also be used at other stages in the design flow if desired (e.g., after logic synthesis). The output of the behavioral simulation tools 608 can be provided to the circuit designer in any suitable format (e.g., truth tables, timing diagrams, etc.).

After the functional operation of the circuit design has been determined to be satisfactory, logic synthesis and optimization tools 610 can generate a gate-level netlist of the circuit design, for example, using gates from a particular library pertaining to a targeted process supported by a foundry that has been selected to produce the integrated circuit. Alternatively, logic synthesis and optimization tools 610 can generate a gate-level netlist of the circuit design using gates of a targeted programmable IC (i.e., in the logic and interconnect resources of a particular programmable IC product or product family).

Logic synthesis and optimization tools 610 can optimize the circuit design by making appropriate selections of hardware to implement different logic functions in the circuit design based on the circuit design data and constraint data entered by the logic designer using tools 602. As an example, logic synthesis and optimization tools 610 can perform multi-level logic optimization and technology mapping based on the length of a combinational path between registers in the circuit design and corresponding timing constraints that were entered by the logic designer using tools 602.

After logic synthesis and optimization using tools 610, the circuit design system 500 can use tools such as placement, routing, and physical synthesis tools 612 to perform physical design steps (layout synthesis operations). Tools 612 can be used to determine where to place each gate of the gate-level netlist produced by tools 610. For example, if two counters interact with each other, tools 612 may locate these counters in adjacent regions to reduce interconnect delays or to satisfy timing requirements specifying the maximum permitted interconnect delay. Tools 612 create orderly and efficient implementations of circuit designs for any targeted integrated circuit (e.g., for a given programmable integrated circuit such as a field-programmable gate array (FPGA)).

Tools such as tools 610 and 612 can be part of a compiler suite (e.g., part of a suite of compiler tools provided by a programmable IC vendor). After an implementation of the desired circuit design has been generated using tools 612, the implementation of the design can be analyzed and tested using analysis tools 614. For example, analysis tools 614 can include timing analysis tools, power analysis tools, or formal verification tools, just to name few.

After satisfactory optimization operations have been completed using tools 600 and depending on the targeted integrated circuit technology, tools 600 can produce a mask-level layout description of the integrated circuit or configuration data for programming the programmable logic IC.

In general, software and data for performing any of the functions disclosed herein can be stored in non-transitory computer readable storage media. Non-transitory computer readable storage media is tangible computer readable storage media that stores data and software for access at a later time, as opposed to media that only transmits propagating electrical signals (e.g., wires). The software code may sometimes be referred to as software, data, program instructions, instructions, or code. The non-transitory computer readable storage media can, for example, include computer memory chips, non-volatile memory such as non-volatile random-access memory (NVRAM), one or more hard drives (e.g., magnetic drives or solid state drives), one or more removable flash drives or other removable media, compact discs (CDs), digital versatile discs (DVDs), Blu-ray discs (BDs), other optical media, and floppy diskettes, tapes, or any other suitable memory or storage device(s).

Additional examples are now described. Example 1 is a method for thermally monitoring an integrated circuit during operation of the integrated circuit, the method comprising: receiving a measurement of a first temperature in a circuit design for the integrated circuit from a temperature sensor; and determining a hottest temperature in the circuit design based on the measurement of the first temperature.

In Example 2, the method of Example 1 may optionally include, wherein determining the hottest temperature of the circuit design comprises calculating the hottest temperature by adjusting the first temperature using a temperature offset between a third temperature measured by the temperature sensor during a design phase of the circuit design and a fourth temperature at a hot spot obtained using a temperature map of the circuit design.

In Example 3, the method of any one of Examples 1-2 further comprises: calculating a margin between the hottest temperature of the circuit design and a maximum temperature of the circuit design.

In Example 4, the method of Example 3 further comprises: controlling cooling provided to the integrated circuit based on the margin using an external thermal control system.

In Example 5, the method of any one of Examples 1˜4 further comprises: identifying hottest locations in the circuit design for the integrated circuit; and identifying temperature monitors in the integrated circuit that are closest to the hottest locations.

In Example 6, the method of Example 5 further comprises: calculating offsets between third temperatures measured by the temperature monitors and fourth temperatures of the hottest locations.

In Example 7, the method of Example 6 may optionally include, wherein determining the hottest temperature in the circuit design comprises calculating the hottest temperature by adjusting the first temperature using one of the offsets corresponding to the temperature sensor.

In Example 8, the method of any one of Examples 1-7 may optionally include, wherein determining the hottest temperature in the circuit design comprises calculating the hottest temperature by correcting the first temperature for an error that is inherent in the measurement of the first temperature generated by the temperature sensor.

Example 9 is an integrated circuit comprising: temperature sensors; and a controller circuit that identifies one of the temperature sensors that is closest to a location in the integrated circuit, wherein the controller circuit calculates a first temperature at the location by correcting a measurement of a second temperature generated by the one of the temperature sensors for an error that is inherent in the measurement of the second temperature generated by the one of the temperature sensors.

In Example 10, the integrated circuit of Example 9 may optionally include, wherein the controller circuit calculates an offset between a third temperature measured by the one of the temperature sensors and a fourth temperature at the location in the integrated circuit obtained using a temperature map of a circuit design for the integrated circuit during a design phase of the circuit design.

In Example 11, the integrated circuit of Example 10 may optionally include, wherein the controller circuit calculates the first temperature at the location by correcting the measurement of the second temperature for the error and for the offset.

In Example 12, the integrated circuit of any one of Examples 9-11 may optionally include, wherein the controller circuit calculates a margin between the first temperature and a target maximum temperature of the integrated circuit.

In Example 13, the integrated circuit of Example 12 may optionally include, wherein an amount of cooling provided to the integrated circuit is controlled based on the margin.

In Example 14, the integrated circuit of any one of Examples 9-13 may optionally include, wherein the controller circuit identifies hottest spots in a circuit design for the integrated circuit and identifies temperature monitors in the integrated circuit closest to the hottest spots during a design phase of the circuit design.

In Example 15, the integrated circuit of Example 14 may optionally include, wherein the controller circuit calculates temperature offsets between third temperatures measured by the temperature monitors and fourth temperatures of the hottest stops, and wherein the controller circuit calculates the first temperature at the location by correcting the measurement of the second temperature for the error and for one of the temperature offsets.

Example 16 is a non-transitory computer readable storage medium comprising computer readable instructions stored thereon for causing a computing system to: receive a measurement of a first temperature in a circuit design for an integrated circuit from a temperature sensor; and determine a second temperature of a cold spot in an active region of the circuit design by adjusting the measurement of the first temperature generated by the temperature sensor by an offset.

In Example 17, the non-transitory computer readable storage medium of Example 16 may optionally include, wherein the computer readable instructions further cause the computing system to calculate the offset between a third temperature measured by the temperature sensor and a coldest temperature in the active region of the circuit design obtained during a design phase of the circuit design.

In Example 18, the non-transitory computer readable storage medium of any one of Examples 16-17 may optionally include, wherein the computer readable instructions further cause the computing system to determine the second temperature of the cold spot in the active region by correcting the measurement of the first temperature for an error that is inherent in the measurement of the first temperature generated by the temperature sensor.

In Example 19, the non-transitory computer readable storage medium of any one of Examples 16-18 may optionally include, wherein the computer readable instructions further cause the computing system to calculate a compensation voltage for a supply voltage provided in the integrated circuit based on the second temperature.

In Example 20, the non-transitory computer readable storage medium of any one of Examples 16-19 may optionally include, wherein the computer readable instructions further cause the computing system to identify a coldest temperature in the active region of the circuit design using a temperature map during a design phase of the circuit design, and wherein the computer readable instructions further cause the computing system to determine the offset based on the coldest temperature.

The foregoing description of the exemplary embodiments has been presented for the purpose of illustration. The foregoing description is not intended to be exhaustive or to be limiting to the examples disclosed herein. The foregoing is merely illustrative of the principles of this disclosure and various modifications can be made by those skilled in the art. The foregoing embodiments may be implemented individually or in any combination.

What is claimed is:

1. A method for thermally monitoring an integrated circuit during operation of the integrated circuit, the method comprising:
receiving a measurement of a first temperature in a circuit design for the integrated circuit from a temperature sensor; and
determining a hottest temperature in the circuit design based on the measurement of the first temperature.

2. The method of claim 1, wherein determining the hottest temperature of the circuit design comprises calculating the hottest temperature by adjusting the first temperature using a temperature offset between a third temperature measured by the temperature sensor during a design phase of the circuit design and a fourth temperature at a hot spot obtained using a temperature map of the circuit design.

3. The method of claim 1 further comprising:
calculating a margin between the hottest temperature of the circuit design and a maximum temperature of the circuit design.

4. The method of claim 3 further comprising:
controlling cooling provided to the integrated circuit based on the margin using an external thermal control system.

5. The method of claim 1 further comprising:
identifying hottest locations in the circuit design for the integrated circuit; and
identifying temperature monitors in the integrated circuit that are closest to the hottest locations.

6. The method of claim 5 further comprising:
calculating offsets between third temperatures measured by the temperature monitors and fourth temperatures of the hottest locations.

7. The method of claim 6, wherein determining the hottest temperature in the circuit design comprises calculating the hottest temperature by adjusting the first temperature using one of the offsets corresponding to the temperature sensor.

8. The method of claim 1, wherein determining the hottest temperature in the circuit design comprises calculating the hottest temperature by correcting the first temperature for an error that is inherent in the measurement of the first temperature generated by the temperature sensor.

9. An integrated circuit comprising:
temperature sensors; and
a controller circuit that identifies one of the temperature sensors that is closest to a location in the integrated circuit, wherein the controller circuit calculates a first temperature at the location by correcting a measurement of a second temperature generated by the one of the temperature sensors for an error that is inherent in the measurement of the second temperature generated by the one of the temperature sensors.

10. The integrated circuit of claim 9, wherein the controller circuit calculates an offset between a third temperature measured by the one of the temperature sensors and a fourth temperature at the location in the integrated circuit obtained using a temperature map of a circuit design for the integrated circuit during a design phase of the circuit design.

11. The integrated circuit of claim 10, wherein the controller circuit calculates the first temperature at the location by correcting the measurement of the second temperature for the error and for the offset.

12. The integrated circuit of claim 9, wherein the controller circuit calculates a margin between the first temperature and a target maximum temperature of the integrated circuit.

13. The integrated circuit of claim 12, wherein an amount of cooling provided to the integrated circuit is controlled based on the margin.

14. The integrated circuit of claim 9, wherein the controller circuit identifies hottest spots in a circuit design for the integrated circuit and identifies temperature monitors in the integrated circuit closest to the hottest spots during a design phase of the circuit design.

15. The integrated circuit of claim 14, wherein the controller circuit calculates temperature offsets between third temperatures measured by the temperature monitors and fourth temperatures of the hottest stops, and wherein the controller circuit calculates the first temperature at the location by correcting the measurement of the second temperature for the error and for one of the temperature offsets.

16. A non-transitory computer readable storage medium comprising computer readable instructions stored thereon for causing a computing system to:
receive a measurement of a first temperature in a circuit design for an integrated circuit from a temperature sensor; and
determine a second temperature of a cold spot in an active region of the circuit design by adjusting the measurement of the first temperature generated by the temperature sensor by an offset.

17. The non-transitory computer readable storage medium of claim 16, wherein the computer readable instructions further cause the computing system to calculate the offset between a third temperature measured by the temperature sensor and a coldest temperature in the active region of the circuit design obtained during a design phase of the circuit design.

18. The non-transitory computer readable storage medium of claim 16, wherein the computer readable instructions further cause the computing system to determine the second temperature of the cold spot in the active region by correcting the measurement of the first temperature for an error that is inherent in the measurement of the first temperature generated by the temperature sensor.

19. The non-transitory computer readable storage medium of claim 16, wherein the computer readable instructions further cause the computing system to calculate a compensation voltage for a supply voltage provided in the integrated circuit based on the second temperature.

20. The non-transitory computer readable storage medium of claim 16, wherein the computer readable instructions further cause the computing system to identify a coldest temperature in the active region of the circuit design using a temperature map during a design phase of the circuit design, and wherein the computer readable instructions further cause the computing system to determine the offset based on the coldest temperature.
